(19) United States
(12) Patent Application Publication
(10) Pub. No.: US 2006/0115390 A1
(43) Pub. Date: Jun. 1, 2006

(54) Plasma discharge reactor and gas treatment device

(75) Inventors: Junichi Tamura, Inagi-shi (JP); Yoshiaki Kaneko, Edogawa-ku (JP); Kenichiro Iuchi, Ohta-ku (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/236,529

(22) Filed: Sep. 28, 2005

(30) Foreign Application Priority Data
Sep. 30, 2004 (JP) 2004-286662
Aug. 24, 2005 (JP) 2005-242928

(51) Int. Cl. B01J 19/08; B01J 19/12

(52) U.S. Cl. 422/186.04; 422/186.21

(57) ABSTRACT

Provided is a plasma discharge reactor including a ground electrode, a high-voltage applying electrode coated with a barrier material, a dielectric member having a three-dimensional network structure comprising a dielectric which is coated with an adsorbent for adsorbing a treating substance contained in a subject gas, and a containing space positioned between the ground electrode and the high-voltage applying electrode, for containing the dielectric member therein. The subject gas is plasma-treated within the dielectric member in the containing space. The dielectric member is in contact with the ground electrode at a contact portion, and the dielectric is exposed at the contact portion. Thereby, generation of a spark discharge between an electrode and a dielectric can be prevented, and an active current other than discharge can also be suppressed.

### BACKGROUND OF THE INVENTION

1. Field of the Invention

The present invention relates to a plasma discharge reactor for treating a gas to be treated (hereinafter, referred to as “subject gas”) containing a substance to be treated (hereinafter, referred to as “treating substance”) by means of plasma and to a gas treatment device.

2. Related Background Art

In recent years, attention has been paid to atmospheric contamination or influences on a human body, attributable to a gas containing a volatile compound or the like. There have been proposed a number of techniques for treating the gas containing a volatile compound or the like. Of those techniques, there has been proposed a gas treatment method and a gas treatment device which are based on a technique by which a gas such as a volatile organic compound (VOC) is treated by plasma discharge, in particular, nonequilibrium plasma discharge.

As such gas treatment device, a structure having a plasma discharge reactor in which a dielectric disposed between electrodes is coated with an adsorbent or a catalyst is disclosed in Japanese Patent Application Laid-open Nos. 2002-153749 and 2004-113704. Japanese Patent Application Laid-open No. 2004-113704 discloses in paragraph [0010] that a honeycomb catalyst is formed by uniformly attaching a dielectric to a substrate made of a dielectric or a substrate made of ceramic or the like, and then attaching a catalyst or an adsorbent thereto, and further discloses in paragraph [0013] that a space of several mm to several cm may be provided between the discharge electrode and the honeycomb catalyst and between the honeycomb catalyst and an opposing electrode, but those elements may be close to or in contact with each other, or one member may intrude into the other member.

However, as to the plasma discharge reactor provided in the above gas treatment device, there is no disclosure in the above publications that, in a case where an electrode and a honeycomb catalyst are in contact with each other, an adsorbent is not attached to the contact portion, or the honeycomb catalyst is exposed at the contact portion. Further, there is no suggestion in the above publications of a structure such that in a case where an electrode and a honeycomb catalyst are in contact with each other, the honeycomb catalyst is exposed at the contact portion. For that reason, with the above plasma discharge reactor, there is a possibility that in a case where an electrode and a honeycomb catalyst are in contact with each other, a spark discharge may be generated between the electrode and a dielectric due to moisture absorbed by the adsorbent attached to the honeycomb catalyst. Moreover, this poses the problems of deterioration of the dielectric and lowering of the treating capacity.

### SUMMARY OF THE INVENTION

It is, therefore, an object of the present invention to provide a plasma discharge reactor and a gas treatment device which suppress the generation of a spark discharge between a first electrode and a dielectric, thereby making it possible to suppress the deterioration of the dielectric or lowering of the treating capacity.

To achieve the above object, the present invention provides a plasma discharge reactor, comprising a first electrode; a second electrode; and a dielectric member having an internal structure comprising a dielectric for allowing a subject gas comprising a treating substance to pass therethrough such that the treating substance is treated in the internal structure, the dielectric member being disposed between the first electrode and the second electrode so as to be in contact with (or abutted against) at least one of the first electrode and the second electrode, wherein both an outer surface of the dielectric member and a wall surface constituting the internal structure of the dielectric member are coated with an adsorbent for adsorbing the treating substance, and wherein the dielectric is exposed at a contact portion thereof with the at least one of the first electrode and the second electrode.

According to the present invention, because at a contact portion of the dielectric member with the electrode, the dielectric is exposed and not coated with the adsorbent, moisture can be suppressed from being adsorbed at the contact portion of the dielectric member. This makes it possible to prevent the generation of a spark discharge between the electrode and the dielectric and to suppress the deterioration of the dielectric and the lowering of the treating capacity.

### BRIEF DESCRIPTION OF THE DRAWINGS

FIG. 1 is a cross sectional view schematically showing a plasma discharge reactor according to a first embodiment of the present invention;

FIG. 2A is a cross sectional view schematically showing a dielectric member used in the plasma discharge reactor according to the first embodiment of the present invention, and FIG. 2B is an enlarged view of portion 2B in FIG. 2A;

FIG. 3A is a cross sectional view schematically showing a dielectric used in a plasma discharge reactor according to a second embodiment of the present invention, and FIG. 3B is an enlarged view of portion 3B in FIG. 3A; and

FIG. 4 is a graphical representation showing relationships between discharge time and processing percentage in Examples 1 and 2 of the present invention and Comparative Examples 1 and 2.

### DETAILED DESCRIPTION OF THE PREFERRED EMBODIMENTS

Now, a description will be given in more detail of preferred embodiments of the present invention with reference to the accompanying drawings.

A plasma discharge reactor according to the present invention is directed to a device for treating a gas containing, for example, a volatile organic compound or an odorous component therein. The plasma discharge reactor can be employed, for example, in facilities such as a factory, a research facility, a hotel, a hospital, or a house. The plasma discharge reactor according to the present invention can treat a treating substance that has been adsorbed to an adsorbent by means of a discharge which develops between a first electrode and a second electrode.

In the plasma discharge reactor according to the present invention, the dielectric member is in contact with at least one electrode of the first electrode and the second electrode. Because the dielectric member and the electrode are in contact with each other, it is possible to stabilize the discharge.

The dielectric member is formed of a dielectric which comprises a material such as ceramic and has such an internal structure as to allow a treating substance to pass therethrough. Examples of the internal structure which allows a treating substance to pass therethrough include a three-dimensional network structure, a honeycomb structure, or a corrugated structure. Further, both an outer surface of the dielectric member and a wall surface that constitutes the internal structure of the dielectric member are coated with an adsorbent. The treating substance is adsorbed to the adsorbent when passing through the internal structure of the dielectric member which is disposed between the electrodes, and is treated by a discharge generated between the electrodes.

Further, the dielectric is exposed at a portion thereof which is in contact with the electrode. That is, the dielectric is in direct contact with the electrode, not through the adsorbent, and the dielectric is not coated with the adsorbent at the portion thereof which is in contact with the electrode, whereby moisture can be suppressed from being adsorbed. This makes it possible to prevent the generation of a spark discharge between the electrode and the dielectric and to suppress the deterioration of the dielectric and the lowering of the treatment capacity.

Examples of the plasma discharge reactor according to this embodiment include a structure of a cartridge type. This refers to a plasma discharge reactor which is detachably attached to a mount part of the gas treatment device. The gas treatment device includes at least the mount on which the plasma discharge reactor of the cartridge type is mounted. Because of the cartridge type, it is possible to readily exchange the plasma discharge reactor as needed.

It is needless to say that the plasma discharge reactor according to the present invention may be not of the above-mentioned cartridge type, but structured to be mounted on the gas treatment device with the difficulty of exchange. Likewise, in this structure, the gas treatment device has a mount part on which the plasma discharge reactor is mounted.

Hereinafter, the preferred embodiments of the present invention will be described with reference to the accompanying drawings, but the present invention is not limited to those embodiments.

### First Embodiment

A plasma discharge reactor according to a first embodiment is directed to a cartridge for conducting a gas treatment (plasma treatment) on a gas containing a treating substance. The plasma discharge reactor has a dielectric exposed at a portion thereof that is in contact with the electrode.

That is, because the dielectric is not coated with the adsorbent at the contact portion, the generation of a spark discharge between the electrode and the dielectric can be prevented, and the deterioration of the dielectric and the lowering of the treatment capacity can be suppressed.

Examples of the treating substance include volatile organic compounds (VOCs), nitrogen oxide (NOx), and odor substances. However, the present invention is not limited to those materials, but applied to any gas material.

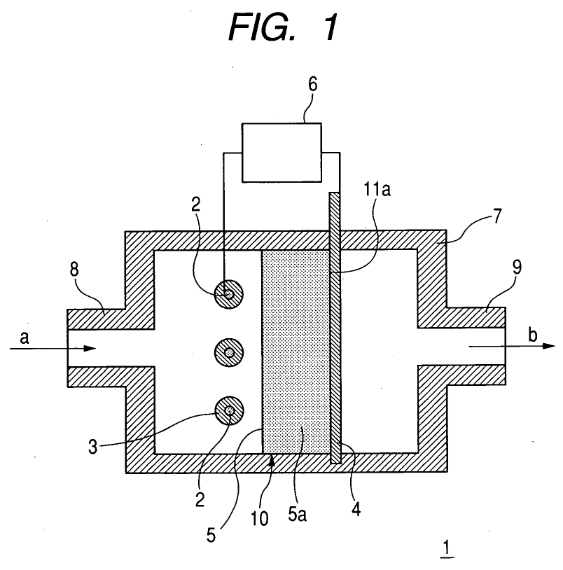

Hereinafter, the plasma discharge reactor according to this embodiment will be described with reference to the accompanying drawings. FIG. 1 shows a cross sectional view of a plasma discharge reactor as a gas treatment according to this embodiment.

First of all, reference symbols in the respective figures will be described. Reference numeral 1 denotes a plasma discharge reactor; 2 is a high-voltage applying electrode; 3 is a barrier material; 4 is a ground electrode; 5 is a dielectric member; 5a is a dielectric; 6 is a power supply; 10 is a containing space; reference symbol 11a is a contact part; reference numeral 12 is a ferroelectric material; 13 is an adsorbent; and 14 is a catalyst-carrying adsorbent. In the figures, reference symbols “a” and “b” denote a subject gas and a treated gas, respectively.

As shown in FIG. 1, the plasma discharge reactor 1 according to this embodiment is directed to a cartridge for treating a gas containing a treating substance, and has a reaction chamber 7 for conducting plasma treatment on the subject gas. In the reaction chamber 7, an inlet 8 for introducing the subject gas therethrough, and an outlet 9 through which the gas that has been plasma-treated is exhausted, are disposed opposite to each other.

The plasma discharge reactor 1 also includes a plurality of ground electrodes 4 which function as first electrodes, and a plurality of high-voltage applying electrodes 2 that function as second electrodes which are disposed apart from the ground electrodes 4. The plasma discharge reactor 1 further includes a dielectric member 5 formed of a dielectric 5a that is coated with an adsorbent 13 for adsorbing the treating substance contained in the subject gas, and a power supply 6 that applies a voltage between the high-voltage applying electrodes 2 and the ground electrodes 4. The ground electrodes 4 and the high-voltage applying electrodes 2 are connected to the power supply 6 through connection wirings, respectively.

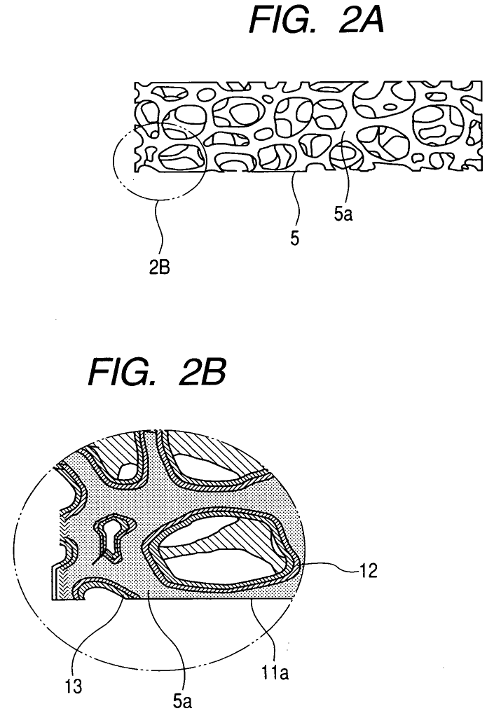

The dielectric member 5 is in contact with the ground electrodes 4 which are the first electrodes as shown in FIG. 1, and is apart from the high-voltage applying electrodes 2 which are the second electrodes. The dielectric member 5 has such an internal structure as to allow the treating substance to pass therethrough. In this embodiment, the dielectric member 5 has a three-dimensional network structure as shown in FIGS. 2A and 2B. Alternatively, the dielectric member 5 may have, for example, a honeycomb structure or a corrugated structure. With the above structures, the surface area of the dielectric 5a becomes large, and the area of the dielectric 5a which is coated with the adsorbent 13 becomes large. The entire three-dimensional network structure of the dielectric 5 including the interior thereof is coated with the adsorbent 13 as shown in FIG. 2B. The term “dielectric” herein employed refers to a material whose dielectric constant is within the range of 10 to 500.

If further needed, it is possible that the dielectric 5a is coated with a ferroelectric material 12, and the ferroelectric material 12 is further coated with the adsorbent 13, as shown in FIG. 2B. The dielectric 5a may be either coated or not coated with the ferroelectric material 12. However, by coating the dielectric 5 with the ferroelectric material 12, the discharge voltage can be lowered to thereby obtain stable discharge. The term “ferroelectric material” herein employed refers to a material whose dielectric constant is within the range of 1600 to 1000.

In order to coat the dielectric 5a with the adsorbent 13, it is preferable that, for example, after the dielectric member 5 is immersed in a solution containing the adsorbent 13 to adhere the adsorbent 13 to the dielectric 5a, the dielectric member 5 is taken out from the solution and dried.

The contact portion 11a of the dielectric member 5 is not coated with the adsorbent 13, so that the dielectric 5a is exposed. That is, since the contact portion 11a is not coated with the adsorbent 13, water is difficult to be adsorbed to the contact portion 11a. In order to obtain the dielectric member 5 in which the dielectric 5a is exposed at the contact portion 11a, it is preferable that after the dielectric member 5 has been coated with the adsorbent, the thus coated adsorbent is removed. Preferred examples of such removing method include, but not limited to, polishing. In removal, the ferroelectric material 12 may be removed together with the adsorbent 13, or not removed to remain.

It is preferable that the ground electrode 4 has a rod shape and is provided in plurality apart from each other. With such configuration, the passage of the subject gas is facilitated. Further, it is preferable that the rod-shaped electrodes of the plurality of the electrodes are arranged parallel to each other. With such arrangement, the distribution of the discharge becomes more uniform, and the treatment efficiency is improved. For the same reason, it is also preferable that the high-voltage applying electrode 2 has a rod shape and is 1.5 provided in plurality apart from each other. In addition, it is preferable that the plurality of electrodes are arranged parallel to each other.

Furthermore, it is preferable that a cross section of the ground electrode 4 in a direction intersecting the longitudinal direction thereof has a contour that is curved. With such structure, a spark discharge becomes difficult to develop, so that the gas can efficiently be treated. It is more preferable that the cross section of the ground electrode 4 has a circular shape. For the same reason, it is preferable that a cross section of the high-voltage applying electrode 2 in a direction intersecting the longitudinal direction thereof has a contour that is curved, and it is more preferable that the cross section of the high-voltage applying electrode 2 has a circular shape.

Further, it is preferable that the longitudinal direction of the rod-shaped ground electrodes 4 intersects the longitudinal direction of the rod-shaped high-voltage applying electrodes 2. Because a discharge is liable to develop in regions where the ground electrodes 4 intersect the high-voltage applying electrodes 2, the gas can efficiently be treated.

Also, it is preferable that the outer periphery of the ground electrode 4 is not covered with a coating material but exposed as a so-called bare electrode. By using the bare electrode, it is possible to effect discharge at a lower voltage.

It is preferable that the outer periphery of the high-voltage applying electrode 2 is coated with a barrier material 3 prepared by forming a dielectric such as ceramic material in a cylindrical shape. By coating the electrodes 2 with the barrier material 3, it is possible to suppress heat from being generated due to the discharge, so that the subject gas can efficiently be treated.

The high-voltage applying electrode 2 and the ground electrode 4 may be formed in another shape such as a wire or mesh shape. Also, the high-voltage applying electrodes 2 and the ground electrodes 4 may be arranged in a fashion opposite to the above-mentioned arrangement, a configuration may be adopted in which the ground electrodes are coated with the barrier material 3, and the high-voltage applying electrodes are not coated and function as bare electrodes. In this configuration, the ferroelectric material and the adsorbent are coated on a portion of the dielectric member other than the contact portion that is brought into contact with the high-voltage applying electrodes.

Also, in the plasma discharge reactor according to this embodiment, the high-voltage applying electrodes 2 coated with the barrier material 3 and the dielectric member 5 are provided apart from each other. However, the present invention is not limited to this configuration, and the high-voltage applying electrodes 2 coated with the barrier material 3 and the dielectric member 5 may be in contact with each other.

For the plasma discharge reactor 1 structured as described above, the operation of treating a gas containing a treating substance will be described.

In the plasma discharge reactor 1, a voltage is applied by the power supply 6 to the high-voltage applying electrodes 2 that are coated with the barrier material 3, thereby producing a nonequilibrium plasma between the high-voltage applying electrodes 2 and the ground electrodes 4 through the dielectric member 5. A subject gas denoted by reference character a is introduced into the reaction chamber 7 through the inlet 8, treated while passing through the dielectric member 5, and then discharged through the outlet 9 to the outside of the system as the treated gas denoted by reference character b.

As described above, according to the plasma discharge reactor 1, since only the contact portion 11a where the dielectric member 5 comes into contact with the ground electrodes 4 is not coated with the adsorbent 13, generation of a spark discharge between the ground electrodes 4 and the contact portion 11a of the dielectric member 5 can be prevented, and active current other than discharge can be suppressed to improve the treatment capacity and the power consumption can be suppressed.

Hereinafter, a plasma discharge reactor according to a second embodiment having a dielectric member different in internal structure from the dielectric member 5 of the first embodiment will be described. In the second embodiment, like elements as those in the first embodiment are indicated with like references, and their description will be omitted.

### Second Embodiment

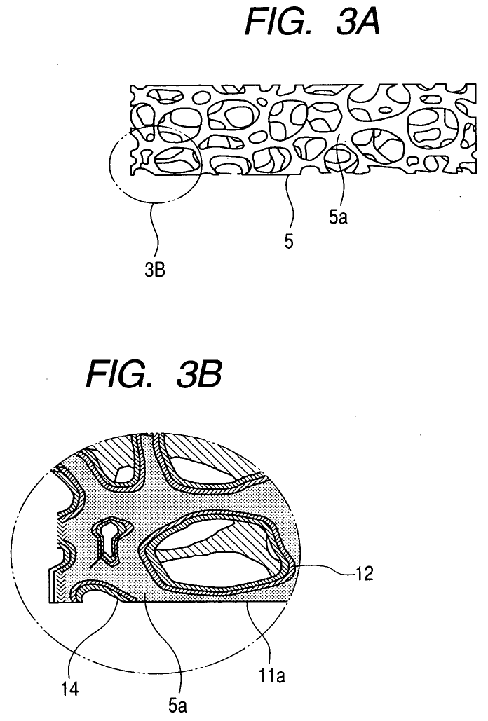

In a plasma discharge reactor according to the second embodiment, a dielectric member such as shown in FIGS. 3A and 3B is employed.

As shown in FIGS. 3A and 3B, a dielectric 5a is coated with a ferroelectric material 12, and the ferroelectric material 12 is further coated with a catalyst-carrying adsorbent 14. The other structure is the same as in the first embodiment. In this embodiment, by coating the dielectric 5a with the catalyst-carrying adsorbent 14 that carries a catalyst, the treatment capacity of the subject gas can be more improved.

The plasma discharge reactor 1 having the above-mentioned basic structure may also be configured as a cartridge that is attachable to and detachable from a mount part of a gas treatment device and usable as a plasma discharge reactor 1 in a state in which the cartridge is mounted on the mount part of the gas treatment device.

Also, although not shown, the gas treatment device according to this embodiment has a mount part on which the above-mentioned plasma discharge reactor 1 is detachably mounted. The gas treatment device effects plasma treatment by means of the plasma discharge reactor 1 in a state in which the plasma discharge reactor 1 of the cartridge type is mounted on the mount part. Moreover, the gas treatment device may be configured such that the above-mentioned plasma discharge reactor 1 is assembled therein.

### EXAMPLES

The advantages of the present invention will be described in more detail with reference to the following examples and reference examples. However, the present invention is not limited to the following examples.

### Example 1

In Example 1, as shown in FIGS. 2A and 2B, a dielectric 5a that was made of ceramic was coated with a ferroelectric material 12, and the ferroelectric material 12 was coated with an adsorbent 13. Further, the dielectric 5a was exposed at a contact portion 11a where the dielectric member 5 was brought into contact with the ground electrodes 4 which were bare electrodes.

The treatment percentage of a treating substance was measured by using the plasma discharge reactor 1 shown in FIG. 1. Rod bars having a diameter of 1 mm were used as the high-voltage applying electrodes 2 and the ground electrodes 4. As the barrier material 3, a cylindrical member was used which was made of alumina and had an inner diameter of 1 mm and an outer diameter of 3 mm.

The dielectric 5a used was alumina as ceramic and had a three-dimensional network structure that was 2 cm³ in volume and 5 mm in thickness. The dielectric 5a was coated with 0.2 g of BaTiO₃ as the ferroelectric material 12, and the ferroelectric material 12 was coated with 0.4 g of hydrophobic zeolite as the adsorbent 13. The hydrophobic zeolite used in this example had a SiO₂/Al₂O₃ molar ratio of 1,000 or more. In the member having the dielectric 5a coated with the ferroelectric material 12 and the adsorbent 13, a surface including the contact portion 11a was entirely polished to remove the ferroelectric material 12 and the adsorbent 13. That is, in the contact portion 11a, the dielectric 5a was exposed and not coated with the ferroelectric material 12 and the adsorbent 13.

As the subject gas a, an air (normal air mainly containing nitrogen and oxygen) based gas containing 5 ppm of NH₃ was used and allowed to flow into the reaction chamber 7 at a flow rate of 20 L/min. Then, a voltage was applied between the high-voltage applying electrodes 2 and the ground electrodes 4 by the power supply 6 to produce a plasma discharge, thereby plasma-treating the air based gas. At this time, the power was set to 1.4 W.

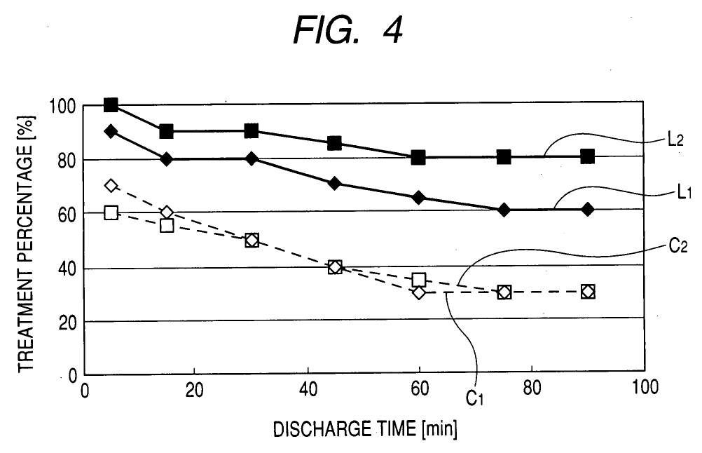

FIG. 4 shows the results obtained by measuring the treated gas b which has been exhausted from the plasma discharge reactor 1 of this example by means of a detector tube. In FIG. 4, a curve L₁ shows the results of Example 1, a curve L₂ shows the results of Example 2, a curve C₁ shows the results of Comparative Example 1, and a curve C₂ shows the results of Comparative Example 2, respectively. As indicated by the curve L₁ in FIG. 4, the treatment percentage after elapse of a discharge time of 90 minutes was 60% in this Example 1.

### Example 2

In this Example 2, as shown in FIGS. 3A and 3B, a dielectric 5a that was made of ceramic was coated with a ferroelectric material 12, and the ferroelectric material 12 was coated with a catalyst-carrying adsorbent 14. Further, the dielectric 5a was exposed at a contact portion 11a where the dielectric member 5 was brought into contact with the ground electrodes 4 which were bare electrodes.

The dielectric 5a used was alumina as ceramic and had a three-dimensional network structure that was 2 cm³ in volume and 5 mm in thickness. The dielectric 5a was coated with 0.2 g of BaTiO₃ as the ferroelectric material 12, and the ferroelectric material 12 was coated with 0.4 g of hydrophobic zeolite which carried 1 wt. % of Ag as the catalyst-carrying adsorbent 14. In the member having the dielectric 5a coated with the ferroelectric material 12 and the catalyst-carrying adsorbent 14, a surface including the contact portion 11a was entirely polished to remove the ferroelectric material 12 and the catalyst-carrying adsorbent 14. That is, in the contact portion 11a, the dielectric 5a was exposed and not coated with the ferroelectric material 12 and the catalyst-carrying adsorbent 14. The other structure and conditions were the same as those in Example 1 described above.

FIG. 4 shows the results obtained by measuring the treated gas b which has been exhausted from the plasma discharge reactor 1 of this example by means of a detector tube. As indicated by the curve L₂ in FIG. 4, the treatment percentage after elapse of a discharge time of 90 minutes was 80% in this Example 2.

### Comparative Example 1

In this Comparative Example 1, there was used a dielectric member 5 obtained by coating the whole surface of a dielectric 5a made of ceramic with a ferroelectric material 12, and then coating the surface of the ferroelectric material 12 with an adsorbent 13 (not shown).

The dielectric 5a used was alumina as ceramic and had a three-dimensional network structure that was 2 cm³ in volume and 5 mm in thickness. The whole surface of the dielectric 5a was coated with 0.3 g of BaTiO₃ as the ferroelectric material 12, and the surface of the ferroelectric material 12 was coated with 0.6 g of hydrophobic zeolite as the adsorbent 13. The thus obtained dielectric 5a was coated at its whole surface including the contact portion 11a with the ferroelectric material 12 and the adsorbent 13 (not shown). The other structure and conditions were the same as those in Example 1 described above.

FIG. 4 shows the results obtained by measuring the treated gas b which has been exhausted from the plasma discharge reactor 1 of this comparative example by means of a detector tube. As indicated by the curve C₁ in FIG. 4, the treatment percentage after elapse of a discharge time of 90 minutes was 30% in this Comparative Example 1.

### Comparative Example 2

In this Comparative Example 2, there was used a dielectric member 5 obtained by coating the whole surface of a dielectric 5a made of ceramic with a ferroelectric material 12, and then coating the surface of the ferroelectric material 12 with a catalyst-carrying adsorbent 14 (not shown).

The dielectric 5a used was alumina as ceramic and had a three-dimensional network structure that was 2 cm³ in volume and 5 mm in thickness. The whole surface of the dielectric 5a was coated with 0.3 g of BaTiO₃ as the ferroelectric material 12, and the surface of the ferroelectric material 12 was coated with 0.6 g of hydrophobic zeolite which carried 1 wt. % of Ag as the catalyst-carrying adsorbent 14. The thus obtained dielectric 5a was coated at its whole surface including the contact portion 11a with the ferroelectric material 12 and the catalyst-carrying adsorbent 14 (not shown). The other structure and conditions were the same as those in Example 1 described above.

FIG. 4 shows the results obtained by measuring the treated gas b which has been exhausted from the plasma discharge reactor 1 of this comparative example by means of a detector tube. As indicated by the curve C₂ in FIG. 4, the treatment percentage after elapse of a discharge time of 90 minutes was 30% in this Comparative Example 2.

As described above, the treatment percentage in Example 2 was the highest, and the treatment percentage of 80% could be obtained. The treatment percentage in Example 1 was also as good as 60%.

On the other hand, in Comparative Examples 1 and 2, the treatment capacities per electric power were lower than those in Examples 1 and 2, and the treatment percentages in Comparative Examples 1 and 2 were as poor as 30%.

This application claims priority from Japanese Patent Application Nos. 2004-286662 filed on Sep. 30, 2004 and 2005-242928 filed on Aug. 24, 2005, which are hereby incorporated by reference herein.

What is claimed is:

1. A plasma discharge reactor, comprising:
a first electrode;
a second electrode; and
a dielectric member having an internal structure comprising a dielectric for allowing a subject gas comprising a treating substance to pass therethrough such that the treating substance is treated in the internal structure, the dielectric member being disposed between the first electrode and the second electrode so as to be in contact with at least one of the first electrode and the second electrode,
wherein both an outer surface of the dielectric member and a wall surface constituting the internal structure of the dielectric member are coated with an adsorbent for adsorbing the treating substance, and
wherein the dielectric is exposed at a contact portion thereof with the at least one of the first electrode and the second electrode.

2. The plasma discharge reactor according to claim 1, wherein the dielectric member is apart from the second electrode.

3. The plasma discharge reactor according to 1, wherein the second electrode is coated with a barrier material.

4. The plasma discharge reactor according to claim 1, wherein the first electrode is a bare electrode.

5. The plasma discharge reactor according to claim 1, wherein the adsorbent carries a catalyst.

6. The plasma discharge reactor according to claim 1, wherein the first electrode has a rod shape and is provided in plurality apart from each other.

7. A plasma discharge reactor according to claim 6, wherein a cross section of the first electrode in a direction intersecting the longitudinal direction thereof has a contour that is curved.

8. The plasma discharge reactor according to claim 6, wherein the second electrode has a rod shape and is provided in plurality apart from each other, and the longitudinal direction of the second electrode intersects the longitudinal direction of the first electrode.

9. The plasma discharge reactor according to claim 1, wherein the portion of the dielectric member being in contact with the at least one of the first electrode and the second electrode is a portion of the dielectric exposed by removing the adsorbent coating the dielectric member.

10. A gas treatment device, comprising:
the plasma discharge reactor set forth in claim 1; and
a mount part for mounting the plasma discharge reactor thereon.
